(19) United States
(12) Patent Application Publication
(10) Pub. No.: US 2025/0173828 A1
(43) Pub. Date: May 29, 2025

(54) INDIRECTIVE TEMPORAL FILTERING FOR ADAPTIVE JOINED PARAMETER SMOOTHING

(71) Applicant: Samsung Electronics Co., Ltd., Suwon-si (KR)

(72) Inventors: Dung Trung Vo, Costa Mesa, CA (US); Chenguang Liu, Tustin, CA (US); McClain C. Nelson, Anaheim, CA (US)

(21) Appl. No.: 18/651,397

(22) Filed: Apr. 30, 2024

Related U.S. Application Data
(60) Provisional application No. 63/603,073, filed on Nov. 27, 2023.

(51) Int. Cl. G06T 5/10

(52) U.S. Cl. CPC G06T 5/10; G06T 2207/10016; G06T 2207/20024

(57) ABSTRACT

One embodiment provides a computer-implemented method that includes applying an adaptive filter in a conversion function that provides temporal smoothness for image output. Indirect input including percentiles are utilized to control one or more filter coefficients of the adaptive filter. Based on the percentiles at different percentages, at least two of the one or more filter coefficients are controlled together to synchronize smoothing for the image output.

### CROSS-REFERENCE TO RELATED APPLICATIONS

This application claims the priority benefit of U.S. Provisional Patent Application Ser. No. 63/603,073, filed on Nov. 27, 2023, which is incorporated herein by reference in its entirety.

### COPYRIGHT DISCLAIMER

A portion of the disclosure of this patent document may contain material that is subject to copyright protection. The copyright owner has no objection to the facsimile reproduction by anyone of the patent document or the patent disclosure as it appears in the patent and trademark office patent file or records, but otherwise reserves all copyright rights whatsoever.

### TECHNICAL FIELD

One or more embodiments relate generally to display imaging enhancement, and in particular, to providing temporal smoothness for image output.

### BACKGROUND

Frame based processing is implemented in many applications, such as encoding, denoising, and image conversion. Flickering issues in frame based processing are caused by high frame changes in a scene or high frame changes at scene boundaries with frame feature delay.

### SUMMARY

One embodiment provides a computer-implemented method that includes applying an adaptive filter in a conversion function that provides temporal smoothness for image output. Indirect input including percentiles are utilized to control one or more filter coefficients of the adaptive filter. Based on the percentiles at different percentages, at least two of the one or more filter coefficients are controlled together to synchronize smoothing for the image output.

Another embodiment includes a non-transitory processor-readable medium that includes a program that when executed by a processor provides temporal smoothness for image output that includes applying, by the processor, an adaptive filter in a conversion function that provides temporal smoothness for image output. The processor utilizes indirect input including percentiles to control one or more filter coefficients of the adaptive filter. The processor controls, based on the percentiles at different percentages, at least two of the one or more filter coefficients together to synchronize smoothing for the image output.

Still another embodiment provides an apparatus that includes a memory storing instructions, and at least one processor executes the instructions including a process configured to apply an adaptive filter in a conversion function that provides temporal smoothness for image output. The process further utilizes indirect input including percentiles to control one or more filter coefficients of the adaptive filter. The process additionally controls, based on the percentiles at different percentages, at least two of the one or more filter coefficients together to synchronize smoothing for the image output.

These and other features, aspects and advantages of the one or more embodiments will become understood with reference to the following description, appended claims and accompanying figures.

### BRIEF DESCRIPTION OF THE DRAWINGS

For a fuller understanding of the nature and advantages of the embodiments, as well as a preferred mode of use, reference should be made to the following detailed description read in conjunction with the accompanying drawings, in which:

FIG. 1 illustrates a block diagram for an example of feature adapted image conversion;

FIG. 2A illustrates an example of an input video sequence;

FIG. 2B illustrates an example of an output video sequence using a frame based dynamic range extension technique;

FIG. 2C illustrates an example sequence of plots of the frame histogram and its conversion function;

FIG. 3A illustrates an example of two successive input frames in a scene;

FIG. 3B illustrates an example of different pixel values in successive output frames in a scene;

FIG. 3C illustrates example histograms for conversion functions for showing that due to the high frame difference, the frame features also have large change;

FIG. 4A illustrates example input frames for showing a flickering issue due to a one frame delayed feature;

FIG. 4B example sequence of plots of the frame histogram and its conversion function for showing a flickering issue due to a one frame delayed feature;

FIG. 4C illustrates example output frames with a one frame delayed feature;

FIG. 5A illustrates an example of three successive input frames at a scene change;

FIG. 5B illustrates an example of different pixel values in successive output frames at a scene change;

FIG. 5C illustrates example histograms for conversion functions showing that due to the high frame difference, the frame features also have large change;

FIG. 6 illustrates an example block diagram of temporal pixel based smoothing;

FIG. 7 illustrates an example of the disclosed technology's feature based adaptive temporal smoothing, according to some embodiments;

FIG. 8 illustrates an example block diagram of feature smoothing, according to some embodiments;

FIG. 9 illustrates an example ramp function of feature difference to filter smoothing coefficient conversion processing, according to some embodiments; and

FIG. 10 illustrates a process for providing temporal smoothness for image output, according to some embodiments.

### DETAILED DESCRIPTION

The following description is made for the purpose of illustrating the general principles of one or more embodiments and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

A description of example embodiments is provided on the following pages. The text and figures are provided solely as examples to aid the reader in understanding the disclosed technology. They are not intended and are not to be construed as limiting the scope of this disclosed technology in any manner. Although certain embodiments and examples have been provided, it will be apparent to those skilled in the art based on the disclosures herein that changes in the embodiments and examples shown may be made without departing from the scope of this disclosed technology.

Some embodiments relate generally to display imaging enhancement, and in particular to providing temporal smoothness for image output. One embodiment provides a computer-implemented method that includes applying an adaptive filter in a conversion function that provides temporal smoothness for image output. Indirect input including percentiles are utilized to control one or more filter coefficients of the adaptive filter. Based on the percentiles at different percentages, at least two of the one or more filter coefficients are controlled together to synchronize smoothing for the image output.

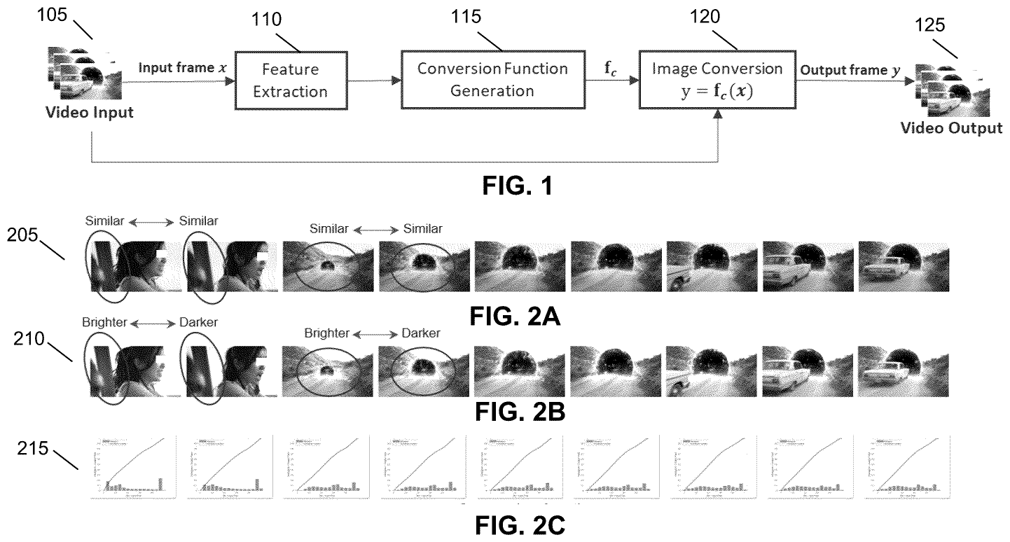

FIG. 1 illustrates a block diagram for an example of feature adapted image conversion. Frame based processing is implemented in many applications, such as encoding, denoising and image conversion. The block diagram shows an example of a frame based image conversion process. At first, a frame feature extraction process 110 is performed on an input frame x of a video input 105. The features can be different types, such as histogram, percentile, edge map, etc. A feature map is then used to estimate the image conversion function by the conversion function generation process 115. Finally, the input image frame x is converted to an output image frame y using the generated conversion function in block 120 for the video output 125.

In comparison to pixel based processing, the frame based methods achieve higher global consistency for all pixels in a frame, but it may introduce a frame delay issue due to frame feature extraction. The feature extraction has to wait until all frame pixels are available to estimate the frame feature, which can cause at least one frame delay for the frame feature map.

In comparison to multi-frame based processing, the frame based methods are more practical with a lower frame memory requirement. However, the frame based methods may introduce frame flickering because it ignores the characteristics of the temporal neighboring frames. Some embodiments address the one frame delay issue and the flickering issue to improve picture quality.

FIG. 2A illustrates an example of an input video sequence 205. The flickering issues in frame based processing are caused by many frame changes in a scene or many frame changes at scene boundaries with a frame feature delay. FIG. 2B illustrates an example of an output video sequence 210 using a frame based dynamic range extension technique. FIG. 2C illustrates an example sequence of plots 215 of the frame histogram and its conversion function. Even when the frame changes are rather smooth in input frames, its outputs still have two instances of flicker (i.e., two “flickerings”). The first flickering is due to sudden frame changes in one scene while the second flickering is due to one frame delayed feature at a scene boundary.

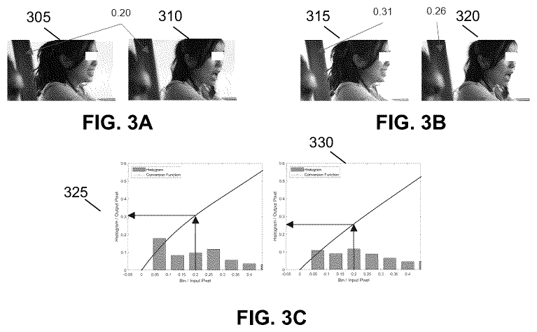

FIG. 3A illustrates an example of two successive input frames (input frames 305 and 310) in a scene. FIG. 3B illustrates an example of different pixel values in successive output frames (output frames 315 and 320) in a scene. FIG. 3C illustrates example histograms 325 and 330 for conversion functions for showing that due to the large frame difference, the frame features also have a large change due to the large frame difference. The frame features (shown as histograms 325 and 330) also have a large change. This leads to a large change in conversion functions as shown in FIG. 3C. That means for the same input pixel value, their output pixel values will be different. For example, two pixels with same value of 0.20 in two frames can have an output pixel value of 0.31 and 0.26. This pixel value jump can cause flickering when displaying the frames in a sequence.

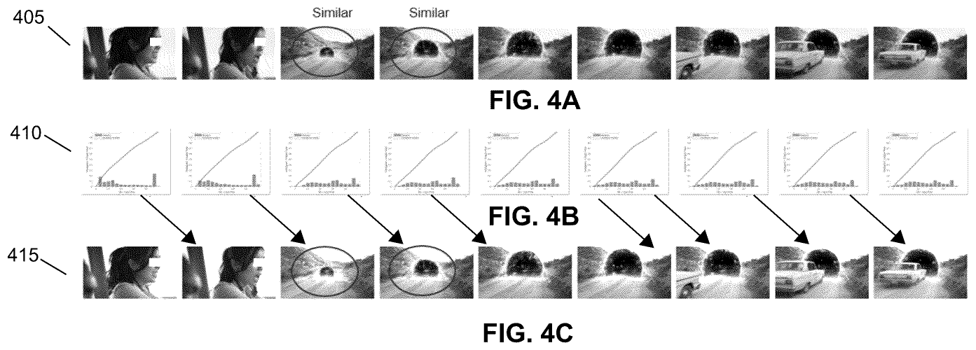

FIG. 4A illustrates example input frames 405 for showing a flickering issue due to a one frame delayed feature. FIG. 4B example sequence of plots 410 of the frame histogram and its conversion function for showing a flickering issue due to a one frame delayed feature. FIG. 4C illustrates example output frames 415 with a one frame delayed feature. In some cases, the frame feature can only be calculated when all the frame pixels are available. This can cause at least one frame delay for the feature map. Because the conversion function is derived based on the frame feature, there can be a frame mismatch between a frame and its conversion function. At scene boundaries, due to this frame feature delay, the beginning frames of a new scene can use the conversion function of the ending frames of the previous scene. This can create flickering between the beginning frames and their following frames of the new scenes.

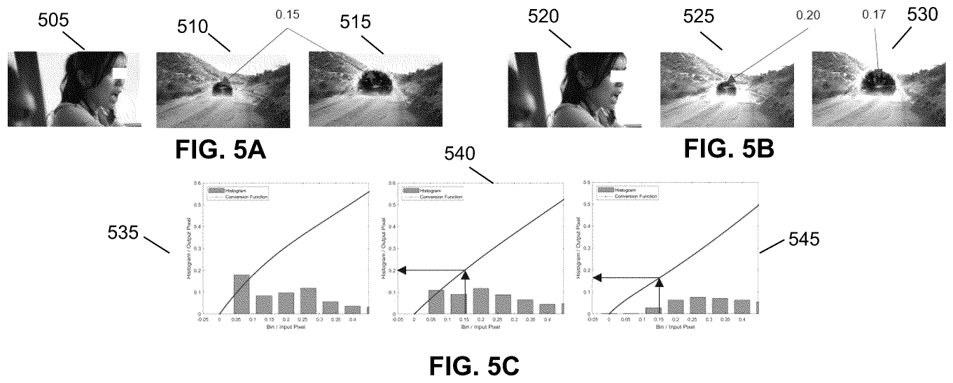

FIG. 5A illustrates an example of three successive input frames 505, 510 and 515 at a scene change. FIG. 5B illustrates an example of different pixel values in successive output frames 520, 525 and 530 at a scene change. FIG. 5C illustrates example histograms 535, 540 and 545 for conversion functions showing that due to the high frame difference, the frame features also have large change. Due to the large frame differences, the frame features (shown as histograms 535, 540 and 545) also change. This leads to a large change in their conversion functions. That means for the same input pixel value in different frames, its output pixel values may be different. For example, two pixels with value of 0.15 in these two scenes can have output pixel values of 0.20 and 0.17 as shown in FIG. 5C. This pixel value jump (as shown in FIG. 5B) can cause flickering when displaying the frames in a sequence.

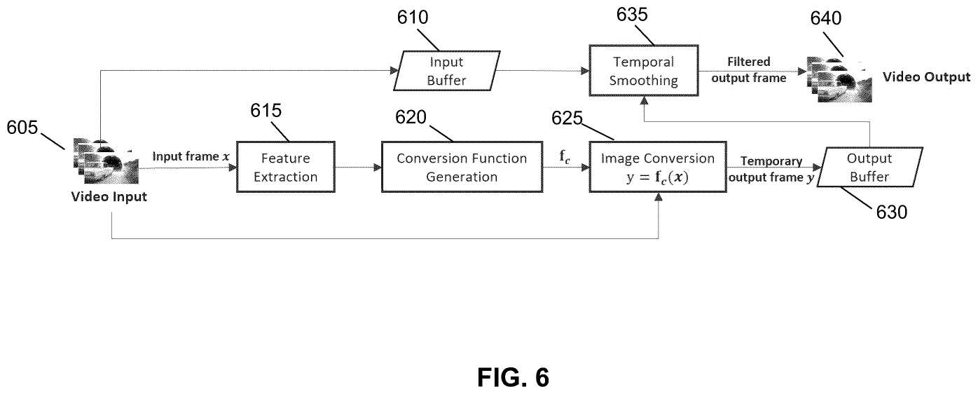

FIG. 6 illustrates an example block diagram of temporal pixel based smoothing. To reduce the flickering, a temporal smoothing filtering process 635 can be applied directly to the pixels. The video input 605 provides the input frame x. The filter inputs can be buffered input frames (from the input buffer 610) and/or output frames. The input frame x is also provided to the feature extraction process 615 and the image conversion function process 625. The conversion function generation process 620 generates the conversion filter f_{c} for the image conversion process 625. A temporary output frame y is stored in the output buffer 630. The temporal smoothing process 635 provides a filtered output frame for the video output 640. If only the buffered input frames are used from the input buffer 610, the filters are classified as finite impulse response (FIR) filters. For infinite impulse response (IIR) filters, both buffered input and output frames are used, which can help to achieve better smoothing. Adaptive smoothing methods can also be implemented to minimize the error between the filter output and the target output. Adaptive temporal filters can adapt its smoothness based on frame difference. This adaptive technique may require an extremely large memory to store the buffered input and/or output frame to calculate the frame difference.

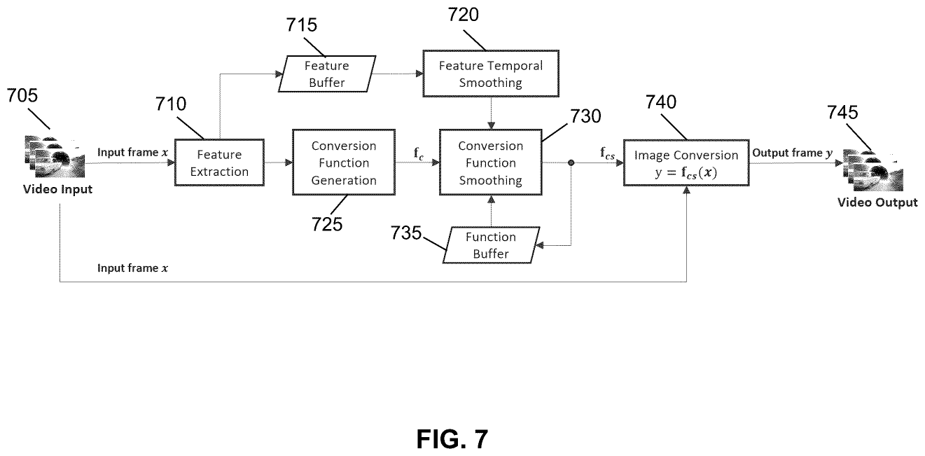

FIG. 7 illustrates an example of the disclosed technology's feature based adaptive temporal smoothing, according to some embodiments. Some cases, unlike some temporal filtering methods that require large multiple frame buffers, one or more embodiments can use a very small size frame feature to adapt the conversion function to reduce the frame delay. Some embodiments can modify the conversion function and can be pixel by pixel processing. As shown, the video input 705 provides an input frame x to feature extraction processing 710 and for image conversion processing 740. The result of the feature extraction processing 710 is provided to a feature buffer 715 and a conversion function generation processing 725. The feature buffer provides one or more features to the feature temporal smoothing processing 720. The conversion function f_{c} (from the conversion function generation processing 725), the result of the feature temporal smoothing processing 720 and a buffered smoothed conversion function (f_{cs}) or coefficients from the function buffer 735 are provided to the conversion function smoothing processing 730. The f_{cs} from the conversion function smoothing processing 730 is provided to the image conversion processing 740. The result from the image conversion processing 740, the output frame y, is provided for the video output 745.

In some embodiments, adaptive smoothing by the conversion function smoothing processing 730 is utilized to achieve smoothing the conversion function f_{c} (from the conversion function generation processing 725) as well as to keep a small frame delay by controlling the filter coefficient based on the feature frame difference. If the feature frame difference is large (conversion function parameter jump is large), then a smoothing filter with a small coefficient value is used to reduce large sudden changes in curve parameters. If the feature frame difference is small (the conversion function parameter jump is low), then a quick filter with a large coefficient value is used to allow the curve parameter to change quickly to reduce the frame delay.

In one or more embodiments, the conversion function smoothing processing 730 is utilized to remove the temporal flickering on the conversion function f_{c}. The inputs of the conversion function smoothing processing 730 (e.g., a smoothing filter, etc.) can be the current conversion function f_{c} and its buffered smoothed conversion functions f_{cs}. In some embodiments, the output of the conversion function smoothing processing 730 can be the filtered conversion function, which can be used to convert the input images into output images. In one or more embodiments, the coefficients of the conversion function smoothing processing 730 smoothing filter can be the output of the feature temporal smoothing processing 720, which can be another smoothing filter. This smoothing filter can avoid sudden change in the filter coefficients of the first filter. The input of this feature smoothing filter can be the feature of current and previous frames.

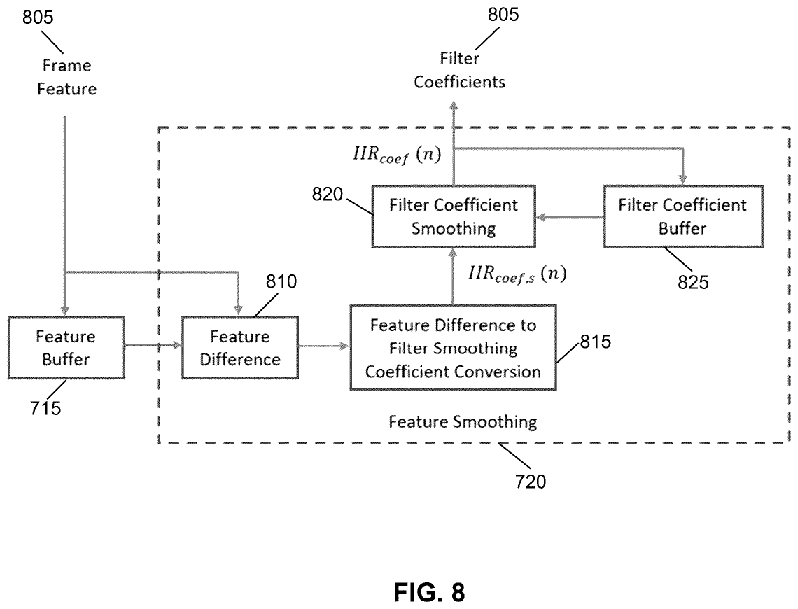

FIG. 8 illustrates an example block diagram of feature smoothing (feature temporal smoothing processing 720), according to some embodiments. As shown, the frame feature 805 (from the feature extraction processing 710, FIG. 7) is provided to the feature buffer 715 and the feature difference processing 810. The feature difference between a current frame and the previous frames can be estimated using the feature difference processing 810. This difference can be used to calculate the filter coefficients to control the conversion function smoothing processing 730 (FIG. 7). In some embodiments, the feature difference can be implemented using the feature difference to filter smoothing coefficient conversion processing 815. To avoid sudden changes on these filter coefficients that can create flickering on the conversion functions, the filter coefficient smoothing processing 820 can be applied to these coefficients and their buffered coefficients from the filter coefficient buffer 825.

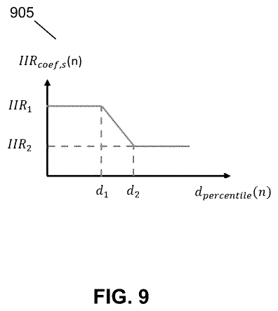

Provided below is an example embodiment of feature temporal smoothing processing 720 with percentiles Perc(n) as a frame feature and IIR filter utilized as the smoothing filter. In one or more embodiments, the feature difference is calculated as shown below:

$${d}_{percentile} ( n ) = {\sum }_{i = 1}^{K} {w}_{i} \vert Perc ( n ) - Perc ( n - i ) \vert$$

where Perc(n) is the percentiles of the current frame n^{th}, Perc(n−i) are the percentiles of the i^{th} previous frames, K is the number of buffered feature frames and wᵢ are the weight for feature difference between the current frame and its buffered frame i^{th}. FIG. 9 illustrates an example ramp function 905 of the feature difference to filter smoothing coefficient conversion processing 815, according to some embodiments. In one or more embodiments, the filter coefficients can be determined as follows:

$${IIR}_{coef , s} ( n ) = \{ \begin{matrix}{IIR}_{1} & if & {d}_{percentile} ( n ) < {d}_{1} \\ {IIR}_{1} + \frac{{IIR}_{2} - {IIR}_{1}}{{d}_{2} - {d}_{1}} ( {d}_{percentile} ( n ) - {d}_{1} ) & if & {d}_{1} \leq {d}_{percentile} ( n ) \leq {d}_{2} \\ {IIR}_{2} & if & {d}_{2} < {d}_{percentile} ( n )\end{matrix}$$

The filter smoothing coefficient can then be used as the IIR filter coefficient to smooth out the filter coefficient IIR_{coef}(n). A general IIR filter can be applied as follows:

$${IIR}_{coef} ( n ) = {\sum }_{i = 0}^{I} {A}_{i} * {IIR}_{coef , s} ( n - i ) + {\sum }_{j = 1}^{J} {B}_{j} * {IIR}_{coef} ( n - j ) .$$

In this example, a simple IIR is presented.

$${IIR}_{coef} ( n ) = {IIR}_{IIR , coef} * {IIR}_{coef , s} ( n ) + ( 1 - {IIR}_{IIR , coef} ) * {IIR}_{coef} ( n - 1 )$$

where IIR_{IIR,coef} is a fixed parameter to smooth out the filter coefficient IIR_{coef}(n).

In some embodiments, the coefficients of the conversion function can be filtered using the filter coefficient output of the feature coefficient processing 820. Below is one example embodiment showing N^{th} order Bernstein polynomial curve coefficients, pᵢ (i=1, . . . , n)

$$\tilde{y} = {\sum }_{i = 1}^{n} {p}_{c , i} ( \begin{matrix}n \\ i\end{matrix} ) {x ( 1 - x )}^{n - i}$$

where x∈[0,1] is the input, \tilde{y}∈[0,1] is output value, and its coefficients p_{cs,i} are filtered as follows:

$${p}_{cs , i} ( n ) = {\sum }_{l = 0}^{L} {C}_{l} * {p}_{c , i} ( n - l ) + {\sum }_{m = 1}^{M} {D}_{m} * {p}_{cs , i} ( n - m ) .$$

In one or more embodiments, a simple IIR filter may be implemented as follows:

$${p}_{cs , i} ( n ) = {IIR}_{coef} ( n ) * {p}_{c , i} ( n ) + ( 1 - {IIR}_{coef} ( n ) ) * {p}_{cs , i} ( n - 1 )$$

where p_{c,i} are curve coefficient outputs of the conversion function generation processing 725 (FIG. 7) and p_{cs,i} are the smoothed curve coefficients.

In some embodiments, the disclosed technology can include (i.e., but is not limited to) smoothing parameters temporally using a frame delay adapted filter based on frame difference. If the frame difference is large, then a smooth IIR filter with a small coefficient value is used to reduce large sudden changes in curve parameters. If the frame difference is small, then a quick IIR filter with a large coefficient value is used to allow the curve parameter to change quickly to reduce the frame delay. In one or more embodiments, the feature smoothing processing 720 does not control filter parameters directly by the filter input or output. The disclosed technology's adaptive filter uses indirect input of percentiles to control the filter coefficients. Some embodiments implement adapting multiple filter parameters using multiple indirect inputs. Percentile values at different percentages are used to control the set of multiple parameters together to synchronize the smoothing effect.

In some embodiments, utilizations of the disclosed technology can include (i.e., but is not limited to) displays (e.g., televisions, smart phones, wearable devices, tablets, laptops, automotive displays, virtual reality (VR) displays, augmented reality (AR) displays, headset displays, digital cameras and camcorders, medical device displays, etc.) that can use adaptive temporal IIR filters to avoid flickering at scene boundaries when a feature based quality enhancement algorithm is applied. The applications can include tone mapping techniques for high dynamic range (HDR) to HDR (HDR2HDR), standard dynamic range (SDR) to HDR (SDR2HDR), HDR to SDR (HDR2SDR), etc. Frame based enhancement such as contrast enhancement, back lighting, denoising, etc., can also utilize the adaptive IIR filter to reduce the flickering between frames. A display can implement the adaptive temporal IIR filter to reduce the filter delay at scene boundaries compared to a fixed IIR filter. In one or more embodiments, the adaptive IIR filter can switch between a linear IIR filter and an adaptive IIR filter, where the adaptive IIR filter may be selected as a default IIR filter. In some embodiments, both a fixed IIR filter and an adaptive IIR filter can smooth out the values over frames, but the adaptive IIR filter permits faster tracking of changes and achieves much less frame delay.

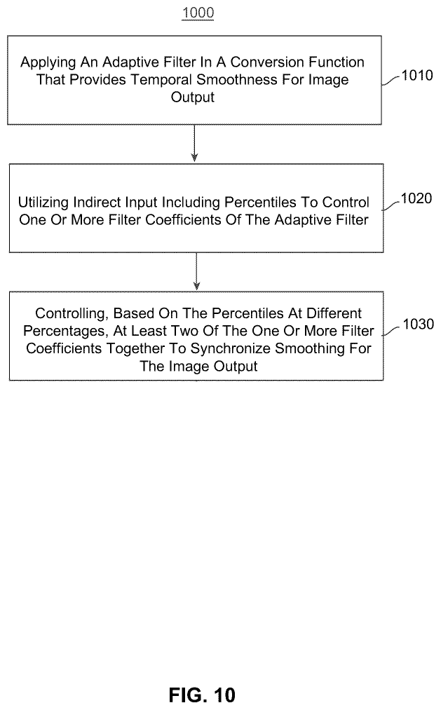

FIG. 10 illustrates a process 1000 for providing temporal smoothness for image output, according to some embodiments. In block 1010, process 1000 applies an adaptive filter in a conversion function that provides temporal smoothness for image output. In block 1020, process 1000 utilizes indirect input including percentiles to control one or more filter coefficients of the adaptive filter. In block 1030, process 1000 controls, based on the percentiles at different percentages, at least two of the one or more filter coefficients together to synchronize smoothing for the image output.

In some embodiments, process 1000 includes the feature that the adaptive filter is configured to adapt the one or more filter coefficients based on a frame feature difference to reduce frame delay.

In one or more embodiments, process 1000 further includes the feature that the indirect input of percentiles is utilized to control the one or more filter coefficients avoids direct control of the one or more filter coefficients by at least one of a filter input or a filter output.

In one or more embodiments, process 1000 additionally provides that the adaptive filter comprises an IIR filter.

In one or more embodiments, process 1000 further includes the feature that upon the frame feature difference exceeding a threshold, the IIR filter with a first coefficient value is used to reduce sudden changes in curve parameters.

In one or more embodiments, process 1000 additionally provides that upon the frame feature difference being less than the threshold, the IIR filter with a second coefficient value is used to provide that the curve parameters change to reduce the frame delay.

In some embodiments, process 1000 includes the feature that the first coefficient value is less than the second coefficient value, the image output comprises video frames provided to a display device (e.g., televisions, smart phones, wearable devices, tablets, laptops, automotive displays, VR displays, AR displays, headset displays, digital cameras and camcorders, medical device displays, etc.).

Embodiments have been described with reference to flowchart illustrations and/or block diagrams of methods, apparatus (systems) and computer program products. Each block of such illustrations/diagrams, or combinations thereof, can be implemented by computer program instructions. The computer program instructions when provided to a processor produce a machine, such that the instructions, which execute via the processor create means for implementing the functions/operations specified in the flowchart and/or block diagram. Each block in the flowchart/block diagrams may represent a hardware and/or software module or logic. In alternative implementations, the functions noted in the blocks may occur out of the order noted in the figures, concurrently, etc.

The terms “computer program medium,” “computer usable medium,” “computer readable medium”, and “computer program product,” are used to generally refer to media such as main memory, secondary memory, removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

As will be appreciated by one skilled in the art, aspects of the embodiments may be embodied as a system, method or computer program product. Accordingly, aspects of the embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the embodiments may take the form of a computer program product embodied in one or more computer readable medium(s) having computer readable program code embodied thereon.

Any combination of one or more computer readable medium(s) may be utilized. The computer readable medium may be a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Computer program code for carrying out operations for aspects of one or more embodiments may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of one or more embodiments are described above with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.”

The terminology used herein is for the purpose of describing particular embodiments only and is not intended to be limiting of the disclosed technology. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the embodiments has been presented for purposes of illustration and description, but is not intended to be exhaustive or limited to the embodiments in the form disclosed. Many modifications and variations will be apparent to those of ordinary skill in the art without departing from the scope and spirit of the disclosed technology.

Though the embodiments have been described with reference to certain versions thereof; however, other versions are possible. Therefore, the spirit and scope of the appended claims should not be limited to the description of the preferred versions contained herein.

What is claimed is:

1. A computer implemented method comprising:
applying an adaptive filter in a conversion function that provides temporal smoothness for image output;
utilizing indirect input including percentiles to control one or more filter coefficients of the adaptive filter; and
controlling, based on the percentiles at different percentages, at least two of the one or more filter coefficients together to synchronize smoothing for the image output.

2. The method of claim 1, wherein the adaptive filter is configured to adapt the one or more filter coefficients based on a frame feature difference to reduce frame delay.

3. The method of claim 1, wherein the indirect input of percentiles to control the one or more filter coefficients avoids direct control of the one or more filter coefficients by at least one of a filter input or a filter output.

4. The method of claim 1, wherein the adaptive filter comprises an infinite impulse response (IIR) filter.

5. The method of claim 4, wherein upon the frame feature difference exceeding a threshold, the IIR filter with a first coefficient value is used to reduce sudden changes in curve parameters.

6. The method of claim 5, wherein upon the frame feature difference being less than the threshold, the IIR filter with a second coefficient value is used to provide that the curve parameters change to reduce the frame delay.

7. The method of claim 6, wherein the first coefficient value is less than the second coefficient value, the image output comprises video frames provided to a display device.

8. A non-transitory processor-readable medium that includes a program that when executed by a processor provides temporal smoothness for image output, comprising:
applying, by the processor, an adaptive filter in a conversion function that provides temporal smoothness for image output;
utilizing, by the processor, indirect input including percentiles to control one or more filter coefficients of the adaptive filter; and
controlling, by the processor, based on the percentiles at different percentages, at least two of the one or more filter coefficients together to synchronize smoothing for the image output.

9. The non-transitory processor-readable medium of claim 8, wherein the adaptive filter is configured to adapt the one or more filter coefficients based on a frame feature difference to reduce frame delay.

10. The non-transitory processor-readable medium of claim 8, wherein the indirect input of percentiles to control the one or more filter coefficients avoids direct control of the one or more filter coefficients by at least one of a filter input or a filter output.

11. The non-transitory processor-readable medium of claim 8, wherein the adaptive filter comprises an infinite impulse response (IIR) filter.

12. The non-transitory processor-readable medium of claim 11, wherein upon the frame feature difference exceeding a threshold, the IIR filter with a first coefficient value is used to reduce sudden changes in curve parameters.

13. The non-transitory processor-readable medium of claim 12, wherein upon the frame feature difference being less than the threshold, the IIR filter with a second coefficient value is used to provide that the curve parameters change to reduce the frame delay.

14. The non-transitory processor-readable medium of claim 13, wherein the first coefficient value is less than the second coefficient value, the image output comprises video frames provided to a display device.

15. An apparatus comprising:
a memory storing instructions; and
at least one processor executes the instructions including a process configured to:
apply an adaptive filter in a conversion function that provides temporal smoothness for image output;
utilize indirect input including percentiles to control one or more filter coefficients of the adaptive filter; and
control, based on the percentiles at different percentages, at least two of the one or more filter coefficients together to synchronize smoothing for the image output.

16. The apparatus of claim 15, wherein the adaptive filter is configured to adapt the one or more filter coefficients based on a frame feature difference to reduce frame delay.

17. The apparatus of claim 15, wherein the indirect input of percentiles to control the one or more filter coefficients avoids direct control of the one or more filter coefficients by at least one of a filter input or a filter output.

18. The apparatus of claim 15, wherein the adaptive filter comprises an infinite impulse response (IIR) filter.

19. The apparatus of claim 18, wherein upon the frame feature difference exceeding a threshold, the IIR filter with a first coefficient value is used to reduce sudden changes in curve parameters.

20. The apparatus of claim 19, wherein:
upon the frame feature difference being less than the threshold, the IIR filter with a second coefficient value is used to provide that the curve parameters change to reduce the frame delay; and
the first coefficient value is less than the second coefficient value, the image output comprises video frames provided to a display device.
